(19) United States
(12) Patent Application Publication
(10) Pub. No.: US 2010/0156835 A1
(43) Pub. Date: Jun. 24, 2010

(54) INFORMATION PROCESSOR AND INFORMATION PROCESSING METHOD

(75) Inventor: Tomoaki Tamura, Oume-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/645,354

(22) Filed: Dec. 22, 2009

(30) Foreign Application Priority Data
Dec. 24, 2008 (JP) 2008-328522

(51) Int. Cl. G06F 3/041

(52) U.S. Cl. 345/173

(57) ABSTRACT

According to one embodiment, an information processor includes a detector and a controller. The detector detects a contacted area. The controller selects an activation mode to activate the information processor based on information related to the contacted area detected by the detector prior to activation of the information processor.

### CROSS-REFERENCE TO RELATED APPLICATIONS

This application is based upon and claims the benefit of priority from Japanese Patent Application No. 2008-328522, filed Dec. 24, 2008, the entire contents of which are incorporated herein by reference.

### BACKGROUND

1. Field

One embodiment of the invention relates to an information processor and an information processing method.

2. Description of the Related Art

A information processor is provided with a switch to select how to activate it to change the activation mode. For example, such an information processor is provided with dedicated switches, one for high-speed activation and the other for normal activation, to allow the user to activate the information processor in a desired mode. With this configuration, the user can select a switch corresponding to a desired activation mode to press it, and the information processor is activated in the selected activation mode selected. Besides, there is a conventional technology of activating the information processor in a predetermined mode by pressing a predetermined key on the keyboard while the information processor is being activated. Further, for example, Japanese Patent Application Publication (KOKAI) No. H11-3129 discloses a conventional technology in which, when a use purpose or a function is specified by the user before (or after) activation of the information processor, the information processor is activated (or reactivated) in such a manner as to have the function corresponding to the use purpose to reduce the activation time and create a dedicated environment.

With the conventional technology using selection switches, the number of activation modes is limited to the number of the selection switches. It is impractical to provide various switches for selecting various types of activation modes. Especially, in the case of a tablet notebook personal computer (PC) having selection switches located on the side of the keyboard, in tablet mode in which the tablet notebook PC is closed with the display screen on the upside, the selection switches are covered by the display screen and cannot be operated. Meanwhile, with the conventional technology disclosed in Japanese Patent Application Publication (KOKAI) No. H11-3129, when turning on the information processor, the user needs to specify a use purpose or a function before activating it, which is troublesome for the user.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of a tablet personal computer (PC) according to an embodiment of the invention;

FIG. 2 is an exemplary block diagram of a hardware configuration of the tablet PC in the embodiment;

FIG. 3 is an exemplary flowchart of the process of activating the tablet PC (activation process 1) in the embodiment;

FIGS. 4A to 4C are an exemplary schematic diagrams for explaining the operations to activate the tablet PC in the embodiment;

FIG. 5 is an exemplary table that stores the number of fingers and setting information used in the activation process 1 in association with each other in the embodiment;

FIG. 6 is an exemplary flowchart of the process of activating the tablet PC (activation process 2) in the embodiment;

FIG. 7 is an exemplary table that stores the shape of a finger and setting information used in the activation process 2 in association with each other in the embodiment;

FIG. 8 is an exemplary flowchart of the process of activating the tablet PC (activation process 3) in the embodiment; and

FIG. 9 is an exemplary table that stores the position of a finger and setting information used in the activation process 3 in association with each other in the embodiment.

### DETAILED DESCRIPTION

Various embodiments according to the invention will be described hereinafter with reference to the accompanying drawings. In general, according to one embodiment of the invention, an information processor comprises a detector and a controller. The detector is configured to detect a contacted area. The controller is configured to select an activation mode to activate the information processor based on information related to the contacted area detected by the detector prior to activation of the information processor.

According to another embodiment of the invention, an information processor comprises a touch panel and a controller. The touch panel is configured to detect a contacted area. The controller is configured to select an activation mode to activate the information processor based on information related to the contacted area detected by the touch panel prior to activation of the information processor.

According to still another embodiment of the invention, there is provided an information processing method for activating an information processor. The information processing method comprises: detecting a contacted area on a detector where an object contacts; and selecting an activation mode to activate the information processor based on information related to the contacted area detected by the detector.

According to still another embodiment of the invention, there is provided an information processing method for activating an information processor. The information processing method comprises: detecting a contacted area on a touch panel where an object contacts; and a controller specifying an activation mode to activate the information processor based on information related to the contacted area detected by the touch panel.

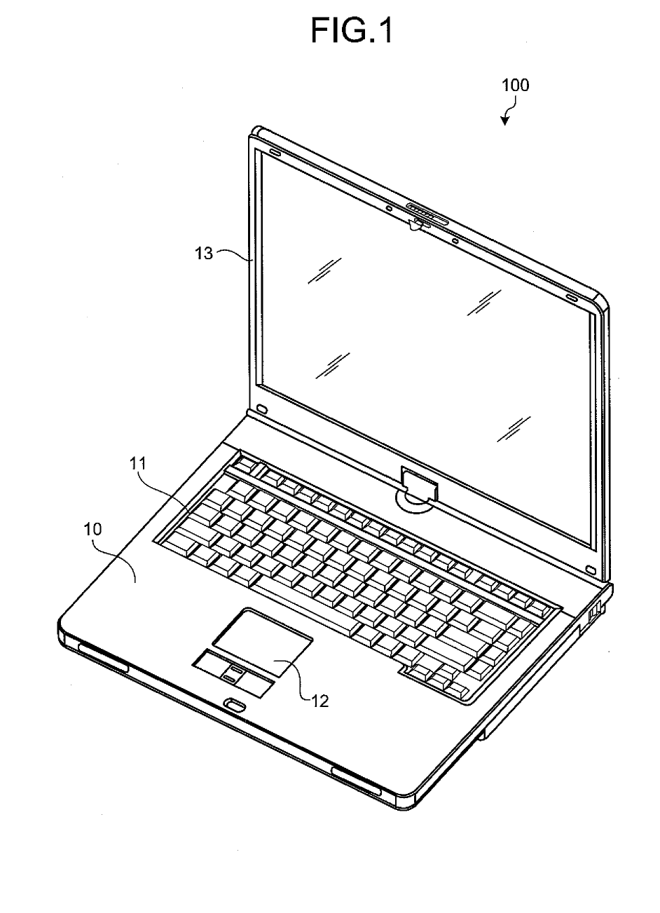

First, a description will be given of a tablet personal computer (PC) according to an embodiment of the invention. FIG. 1 is a perspective view of a tablet PC 100 according to the embodiment.

The tablet PC 100 is a computer system comprising input devices such as a keyboard 11 and a touchpad 12, and a display device 13. The display device 13 is provided with a touch panel on its surface to detect the coordinates of a position where a stylus pen, a finger, etc. touches, the touched area (contacted area), and the like.

As illustrated in FIG. 1, the tablet PC 100 comprises a main body 10 having the keyboard 11 and the touchpad 12 mounted thereon. Various types of hardware is built in the main body 10.

The tablet PC 100 further comprises the display device 13 provided with a display panel such as a liquid crystal display (LCD) and a tablet (the touch panel). The tablet is integrated with the surface of the display panel. The display module 13 is rotatably attached to the main body 10 through a rotary biaxial hinge mechanism. This allows the display module 13 to rotate between a closed position and an open position. FIG. 1 illustrates the display module 13 in the closed position (in laptop mode). The display module 13 can rotate 180 degrees into the closed position (into tablet mode) so that it covers over the keyboard 11.

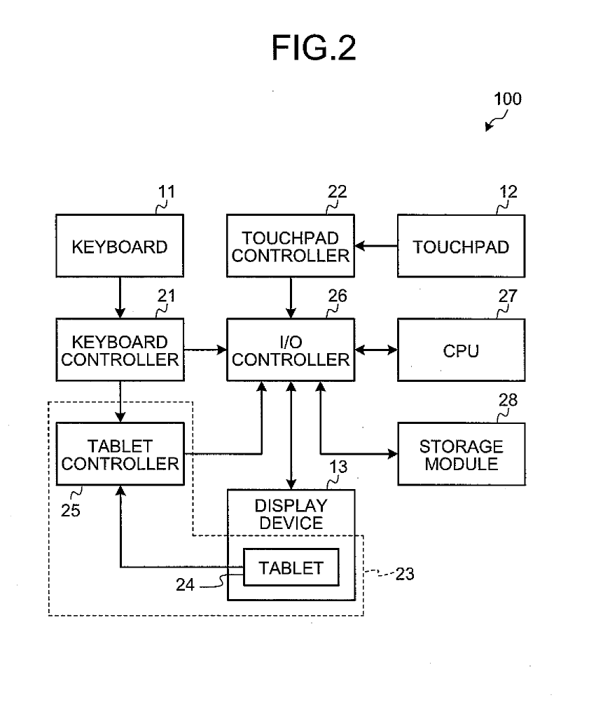

A description will then be given of a hardware configuration of the tablet PC 100. FIG. 2 illustrates the hardware configuration of the tablet PC 100.

As illustrated in FIG. 2, the tablet PC 100 comprises a keyboard controller 21 that converts input from the keyboard 11 to input data to input the input data to the main body 10. The tablet PC 100 further comprises a touchpad controller 22 that converts input from the touchpad 12 to input data to input the input data to the main body 10.

The tablet PC 100 is provided with a tablet input device 23 as a data input device in addition to the keyboard 11 and the touchpad 12. The tablet input device 23 comprises a tablet 24 (the touch panel) and a tablet controller 25. The tablet 24 detects the coordinates of a position where a stylus pen, a finger, etc. touches, the touched area (contacted area), and the like. The tablet controller 25 converts the coordinates, the contacted area, and the like to input data.

The main body 10 comprises an input/output (I/O) controller 26. The I/O controller 26 sends the input data received from the keyboard controller 21, the touchpad controller 22, and the tablet controller 25 to a microprocessor or a central processing unit (CPU) 27. In addition, the I/O controller 26 controls the output operation of the display module 13 as well as the input operation of a storage module 28 under the control of the CPU 27.

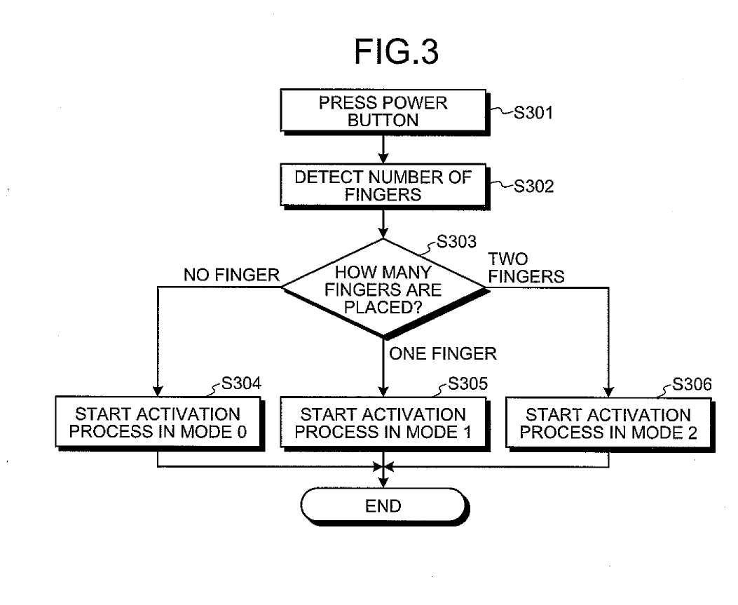

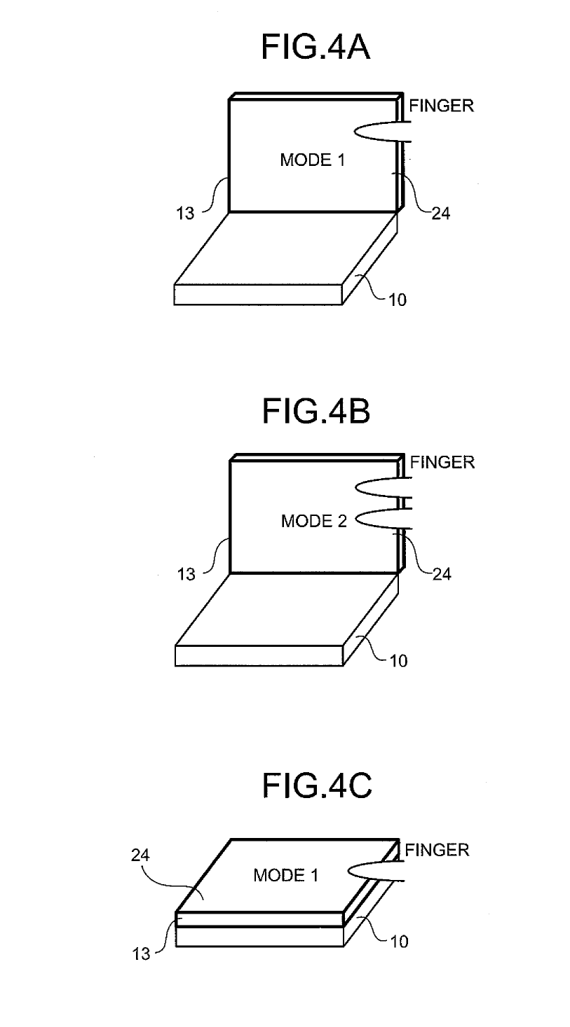

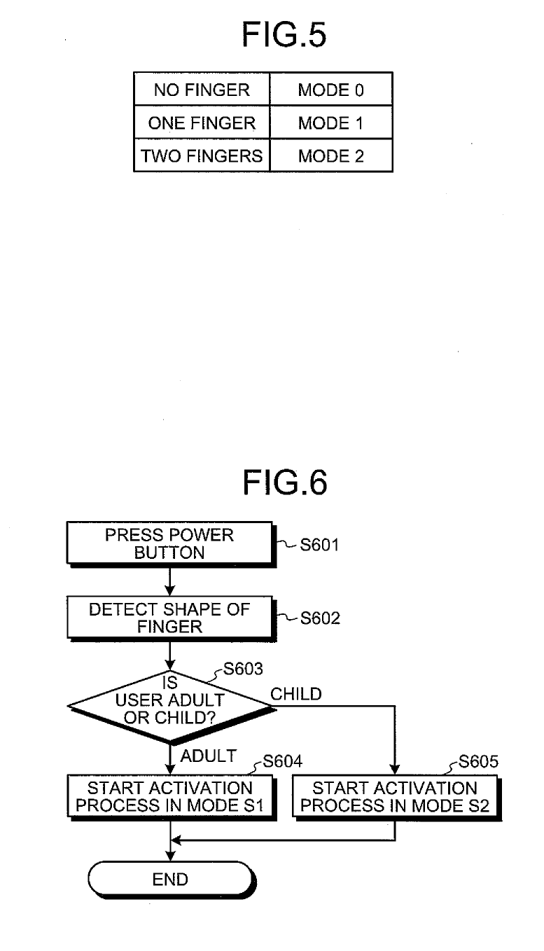

In the following, with reference to FIGS. 3 to 5, a description will be given of the process of activating the tablet PC 100 as configured above (activation process 1). FIG. 3 is a flowchart of the process of activating the tablet PC 100 (activation process 1). FIGS. 4A to 4C are schematic diagrams for explaining an example of operations to activate the tablet PC 100. FIG. 5 is an example of a table that stores the number of fingers to be detected and setting information used in the activation process 1 in association with each other.

First, when the power button is pressed (S301), the tablet PC 100 detects how many fingers are placed on the tablet surface thereof, i.e., the number of user's fingers placed on the tablet surface thereof as illustrated in FIGS. 4A to 4C (S302). Note that, as illustrated in FIG. 4, the number of user's fingers placed on the tablet surface of the tablet PC 100 can be detected in both the laptop mode as illustrated in FIG. 4A and the tablet mode as illustrated in FIG. 4C. As can be seen from FIGS. 4A to 4C, the user activates the tablet PC 100 while touching the tablet 24. Incidentally, it is obvious that the tablet PC 100 can be activated if the user does not touch the tablet 24.

Next, with reference to the table as illustrated in FIG. 5, the tablet PC 100 determines the activation mode in which it is activated according to the number of detected user's fingers (S303). It is herein assumed that 0 to two fingers have been detected. At this time, the tablet input device 23 detects the position of user's finger placed on the tablet surface and the contacted area, and, if a plurality of fingers touch the tablet surface, detects a space between the fingers. With this information, the tablet PC 100 determines the number of user's fingers placed on the tablet surface thereof.

If no finger is detected, the tablet PC 100 starts the activation process in a predetermined setting, i.e., in Mode 0 (S304). Similarly, if one finger is detected, the tablet PC 100 starts the activation process in another predetermined setting, i.e., in Mode 1 (S305), and if two fingers are detected, the tablet PC 100 starts the activation process instill another predetermined setting, i.e., in Mode 2 (S306).

In the embodiment, as illustrated in FIG. 5, the table stores the number of detected fingers and a setting to activate the tablet PC 100 in association with each other. With reference to the table, the tablet PC 100 starts the activation process in a setting associated with the number of detected fingers. While in the above description, the tablet PC 100 is described as detecting 0 to two user's fingers, this is by way of example and not by way of limitation. The tablet PC 100 may detect three or more fingers and start the activation process in one of four or more activation modes.

Besides, according to the embodiment, the tablet PC 100 may be activated to create an emergency environment by touching the tablet surface with one finger. Further, the tablet PC 100 may be activated so that the mailer is invoked immediately after the activation by touching the tablet surface with four fingers. In addition, the tablet PC 100 is capable of detecting the socket at the joint of a finger. In other words, the tablet PC 100 is capable of detecting each joint of a finger based on the socket at the joint. Thus, the tablet PC 100 may detect whether a finger is in contact with the tablet surface up to the first joint, the second joint, or the third joint, and determine the mode of the activation process according to the determination result.

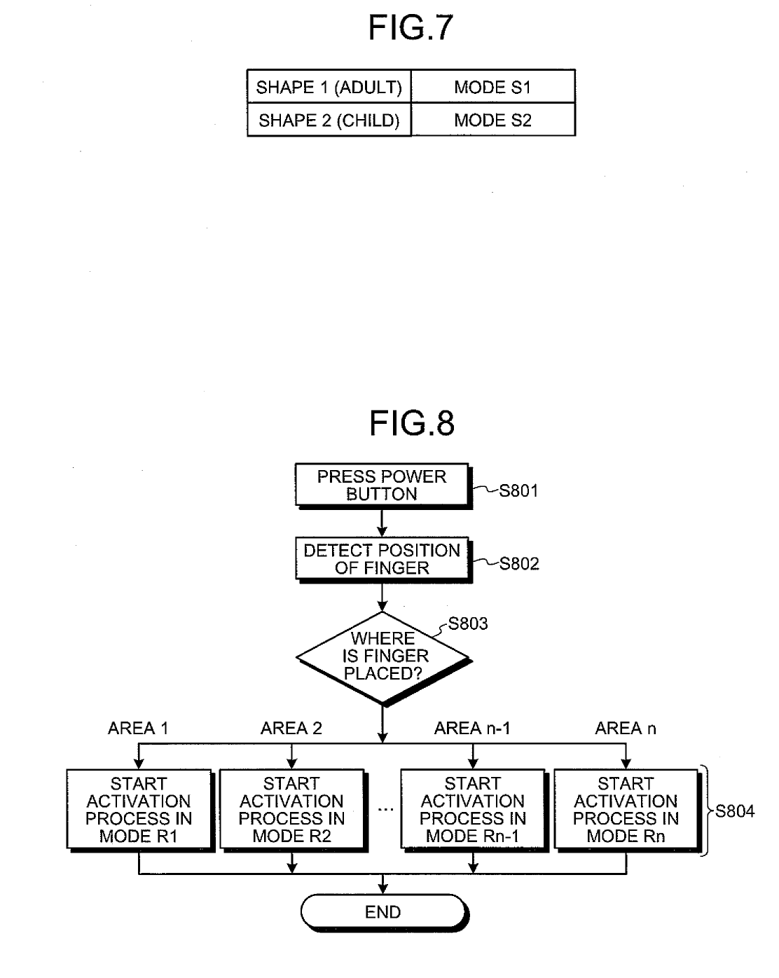

In the activation process 1 described above, the activation mode in which the tablet PC 100 is activated is determined according to the number of user's fingers placed on the tablet surface thereof. However, by detecting the shape or form of user's finger (the shape or form of user's hand) placed on the tablet surface of the tablet PC 100, the activation mode may be determined according to the detected shape or form. In the following, this activation process will be described as activation process 2 with reference to FIGS. 6 and 7. FIG. 6 is a flowchart of the process of activating the tablet PC 100 (activation process 2). FIG. 7 illustrates an example of a table that stores the shape of a finger to be detected and setting information used in the activation process 2 in association with each other.

In the activation process 2 of the embodiment, in view of that the shape, size, etc. is different between the adult's finger or hand and the child's finger or hand, the activation mode is determined based on the difference. More specifically, when determining that the user is an adult, the tablet PC 100 starts the activation process in a setting for an adult user. On the other hand, when determining that the user is a child, the tablet PC 100 starts the activation process in a setting for an child user.

First, when the power button is pressed (S601), the tablet PC 100 detects the shape of user's finger placed on the tablet surface thereof (S602). On this occasion, the shape of user's finger placed on the tablet surface of the tablet PC 100 can be detected in both the laptop mode and the tablet mode.

Next, with reference to the table as illustrated in FIG. 7, the tablet PC 100 determines the activation mode in which it is activated according to the detected shape of user's finger (S603). At this time, since the tablet input device 23 can detect the position of user's finger placed on the tablet surface and the contacted area, the tablet PC 100 can obtain the shape pattern of the finger from information on the position and the contacted area. Based on the shape pattern and shape information (for example, the size of the finger) stored in the table as illustrated in FIG. 7, the tablet PC 100 can determine whether the shape of user's finger placed on the tablet surface is that of the adult's finger or the child's finger.

Having determined that the user is an adult based on the detected shape of user's finger, the tablet PC 100 starts the activation process in a predetermined setting for an adult user, i.e., in Mode S1 (S604). Similarly, having determined that the user is a child, the tablet PC 100 starts the activation process in a predetermined setting for a child user, i.e., in Mode S2 (S605). As illustrated in FIG. 7, the table stores the shapes of fingers to be detected each in association with a setting or a mode to activate the tablet PC 100. With reference to the table, the tablet PC 100 starts the activation process in a setting or a mode corresponding to the detected shape of user's finger. In this manner, by controlling the activation mode in which the tablet PC 100 is activated, for example, if a child user activates the tablet PC 100, the tablet PC 100 can be activated such that functions or the like preferably not allowed to children are restricted or disabled.

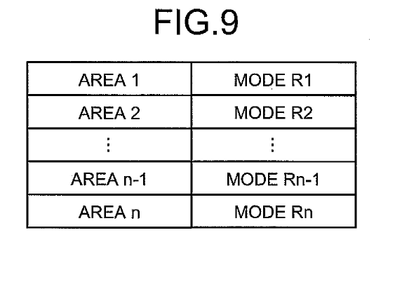

In the activation process 1 and the activation process 2 described above, the activation mode in which the tablet PC 100 is activated is determined according to the number of user's fingers or the shape of user's finger placed on the tablet surface of the tablet PC 100. However, by detecting the position (coordinates) of user's finger placed on the tablet surface of the tablet PC 100, the activation mode may be determined according to the detected position. In the following, this activation process will be described as activation process 3 with reference to FIGS. 8 and 9. FIG. 8 is a flowchart of the process of activating the tablet PC 100 (activation process 3). FIG. 9 illustrates an example of a table that stores the position of a finger to be detected and setting information used in the activation process 3 in association with each other.

First, when the power button is pressed (S801), the tablet PC 100 detects where the user places his/her finger on the tablet surface thereof, i.e., the position of user's finger placed on the tablet surface thereof (S802). On this occasion, the position of user's finger placed on the tablet surface of the tablet PC 100 can be detected in both the laptop mode and the tablet mode.

Next, with reference to the table as illustrated in FIG. 9, the tablet PC 100 determines the activation mode in which it is activated according to the detected position of user's finger, i.e., area 1, area 2, . . . , area n-1, or area n (S803). At this time, through the tablet input device 23, the tablet PC 100 can detect the position of user's finger placed on the tablet surface.

After that, the tablet PC 100 starts the activation process in Mode R1, Mode R2, . . . , Mode Rn-1, or Mode Rn (n: an integer) associated with the detected position of user's finger, i.e., the area 1, 2, . . . , n-1, or n. In the embodiment, as illustrated in FIG. 9, the table stores a setting or a mode of the activation process in associated with a predetermined area on the tablet surface, i.e., the area 1, 2, . . . , n-1, or n. With reference to the table, the tablet PC 100 starts the activation process in a mode associated with an area including the position (coordinates) of user's finger. In the activation process 3, the tablet PC 100 can be activated in various type of settings compared to the activation process 1 and the activation process 2 described above.

In the activation processes 1, 2 and 3 described above, the tablet PC 100 detects the number of user's fingers, the shape of user's finger, or the position of user's fingers placed on the tablet surface thereof. Then, the tablet PC 100 determines the activation mode in which it is activated according to the detection result. However, the tablet PC 100 may be activated according to an arbitrary combination of the activation processes 1, 2, and 3. In this case, the user can select an activation mode from more various types of activation modes. For example, a combination of the activation processes 1 and 2, a combination of the activation processes 2 and 3, or a combination of the activation processes 1, 2, and 3 allows both the adult user and the child user to select an activation mode from more various types of activation modes.

It is assumed herein that the CPU 27 performs each of the activation processes described above by executing a basic input-output system (BIOS) from when the tablet PC 100 is turned on. However, each of the activation processes may be performed by a utility program executed after the process of the BIOS.

As set forth hereinabove, according to the embodiment, in the activation processes, a plurality of activation modes may be switched without additionally providing a switch or a button. Moreover, since an activation mode is specified by using the tablet of the tablet PC, the user can select a desired activation mode from a plurality of activation modes even in the tablet mode. Further, in addition to the normal activation mode, the user can arbitrarily select an activation mode for high-speed or power-saving activation, simplification of functions, and the like. Besides, in each of the activation processes, the settings may include a setting for specifying an application to be executed immediately after the system is activated. In this case, it is possible to create a system environment in which the application desired by the user can be used immediately after the system is activated. In addition, in the process of activating the tablet PC, a selection screen may be displayed for selecting an activation mode so that the user can select an activation mode by touching the selection screen with his/her finger or the like.

Incidentally, a computer program may be executed on the tablet PC 100 to realize the activation processes as described above. The computer program may be provided as being stored in advance in a read only memory (ROM) or the like. The computer program may also be provided as being stored in a computer-readable storage medium, such as a compact disk-read only memory (CD-ROM), a flexible disk (FD), a compact disc-recordable (CD-R), or a digital versatile disc (DVD), as a file in an installable or executable format. Further, the computer program may also be stored in a computer connected via a network such as the Internet so that it can be downloaded therefrom.

While the activation mode is described above as being determined based on user's finger, it is not so limited. For example, the user can specify the activation mode using a stylus pen or the like.

The various modules of the systems described herein can be implemented as software applications, hardware and/or software modules, or components on one or more computers, such as servers.

While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processor comprising:
a detector configured to detect a contacted area; and
a controller configured to select an activation mode to activate the information processor based on information related to the contacted area detected by the detector prior to activation of the information processor.

2. The information processor of claim 1, wherein the controller comprises:
a first determination module configured to determine a number of objects contacting the detector as the information related to the contacted area detected by the detector, and
a first mode selecting module configured to select the activation mode based on the number of objects determined by the first determination module.

3. The information processor of claim 1, wherein the controller comprises:
a second determination module configured to determine a shape of an object contacting the detector as the information related to the contacted area detected by the detector, and
a second mode selecting module configured to select the activation mode based on the shape of the object determined by the second determination module.

4. The information processor of claim 1, wherein the controller comprises:
a third determination module configured to determine a position of an object contacting the detector as the information related to the contacted area detected by the detector, and a third mode selecting module configured to select the activation mode based on the position of the object determined by the third determination module.

5. An information processor comprising:
a touch panel configured to detect a contacted area of an object; and
a controller configured to select an activation mode to activate the information processor based on information related to the contacted area detected by the touch panel prior to activation of the information processor.

6. The information processor of claim 5,
a first determination module configured to determine a number of objects contacting the contacted area as the information related to the contacted area detected by the touch panel, and
a first mode selecting module configured to select the activation mode based on the number of objects determined by the first determination module.

7. The information processor of claim 5, wherein the controller comprises:
a second determination module configured to determine a shape of an object contacting the contacted area as the information related to the contacted area detected by the touch panel, and
a second mode selecting module configured to select the activation mode based on the shape of the object determined by the second determination module.

8. The information processor of claim 5, wherein the controller comprises:
a third determination module configured to determine a position of an object contacting the contacted area as the information related to the contacted area detected by the touch panel, and
a third mode selecting module configured to select the activation mode based on the position of the object determined by the third determination module.

9. An information processing method for activating an information processor comprising:
detecting a contacted area on a detector where an object is contacting; and
selecting an activation mode to activate the information processor based on information related to the contacted area detected by the detector.

10. An information processing method for activating an information processor comprising:
detecting a contacted area on a touch panel where an object is contacting; and
selecting an activation mode to activate the information processor based on information related to the contacted area detected by the touch panel.
